(19) United States
(12) Patent Application Publication
(10) Pub. No.: US 2017/0302930 A1
(43) Pub. Date: Oct. 19, 2017

(54) METHOD OF TRANSCODING VIDEO DATA WITH FUSION OF CODING UNITS, COMPUTER PROGRAM, TRANSCODING MODULE AND TELECOMMUNICATIONS EQUIPMENT ASSOCIATED THEREWITH

(71) Applicants: INSTITUT MINES TELECOM, Paris - Cedex 13 (FR); CENTRE NATIONAL DE LA RECHERCHE SCIENTIFIQUE - CNRS, Paris (FR)

(72) Inventors: Elie Gabriel Mora, Paris (FR); Marco Cagnazzo, Gentilly (FR); Frederic Dufaux, Nanterre (FR)

(21) Appl. No.: 15/515,835

(22) PCT Filed: Sep. 30, 2015
(86) PCT No.: PCT/FR2015/052610

§ 371 Date: Mar. 30, 2017

(30) Foreign Application Priority Data
Sep. 30, 2014 (FR) 14 59324

(51) Int. Cl. H04N 19/119; H04N 19/513; H04N 19/139; H04N 19/192; H04N 19/147; H04N 19/96; H04N 19/436; H04N 19/40

(52) U.S. Cl. CPC H04N 19/119; H04N 19/96; H04N 19/513; H04N 19/436; H04N 19/139; H04N 19/192; H04N 19/147; H04N 19/40

(57) ABSTRACT

Method of transcoding video data with fusion of coding units, computer program, transcoding module and telecommunications equipment associated therewith. Method of transcoding video data between a first and a second format (F1, F2), the method comprising a step of decoding the binary stream (F_{B1}) providing decoded video data, data representative of the coding structure of the frames in the first format (F1) and, for all or some of the first coding units, prediction data, and a step of re-encoding in the course of which the decoded video data are encoded in the second format (F2). During the re-encoding step, an intermediate coding structure is constructed, comprising intermediate coding units constructed so as to correspond to the fusion of one or more first coding units, prediction data are allocated to each of the intermediate coding units, and the decoded video data are re-encoded in the second format (F2) as a function of the intermediate coding structure.

The invention relates to a method of transcoding a bitstream containing video data in a first format, into a bitstream containing said video data in a second format.

Video transcoding is used in many applications, for example for compressing data to facilitate distribution or to allow display on devices that do not support certain formats.

Several transcoding techniques exist, including a technique called “Full Decode-Full Encode.” In this method, the data are decoded then fully re-encoded in the target format. This technique has the advantages of being independent of the initial format and target format and of providing the best coding efficiency, but has the major disadvantage of requiring significant computational power and of being slow to apply. It is therefore unsuitable for some applications, particularly in real-time applications where the transcoding speed is a critical criterion.

Other transcoding methods have been developed. These methods are essentially based on the principle of associating coding modes and/or on the principle of reusing motion vectors associated with coding units of the coding structure of each frame of video data in the first format.

The principle of associating coding modes involves determining the precise form of the coding units of the second format by applying a limit to the possible subdivisions of the coding units, or not evaluating certain coding modes or certain partitions.

The principle of re-using motion vectors involves applying a method of estimating the motion of coding units in which the estimation performed for coding units encoded in Inter mode is simplified by eliminating the testing of certain positions.

These methods also have disadvantages. Indeed, in these methods, construction of the coding structure that the frames will have in the second format may still be particularly complex. In addition, some of these coding methods are unsuitable for certain applications.

The invention improves the situation.

To this end, the invention relates to a method of transcoding a bitstream containing video data in a first format into a bitstream containing said video data in a second format, the video data comprising frames, said frames being divided in the first format into first coding units each covering a region of the frame and defining a first coding structure for each frame, and being divided in the second format into second coding units defining a second coding structure for each frame, the method comprising:
a bitstream decoding step providing decoded video data, data representative of the first coding structure of the frames and, for each of the first coding units, prediction data, the prediction data of at least one first coding unit comprising a motion vector, and
a re-encoding step during which the decoded video data are encoded in the second format.

In particular, during the re-encoding step, for at least one frame of video data:
an intermediate coding structure is constructed, comprising intermediate coding units each constructed to correspond to the merging of one or more first coding units covered by said intermediate coding unit when a first condition is satisfied, the first condition being that at least one dissimilarity metric associated with the first coding unit or units in question and determined from motion vectors of said first coding units is less than a predetermined threshold, at least one intermediate coding unit corresponding to the merging of at least two first coding units,
each of the intermediate coding units is assigned prediction data constructed from prediction data of the first coding unit or units merged to form said intermediate coding unit, and
the decoded video data are re-encoded in the second format by constructing the second coding structure based on the intermediate coding structure.

The construction of the coding structure of the second format is thus directly impacted by the coding structure of the first, which reduces the transcoding complexity. In particular, in a manner of speaking the size of the first coding units serves as a minimum size for the intermediate coding units.

In addition, this transcoding method is independent of the maximum size of the coding units in both formats, which makes this method suitable for a large number of formats. Moreover, the transcoding method does not require particularly significant computing power, which contributes to its suitability for many applications, including real-time applications.

According to one aspect of the invention, for the construction of the intermediate coding structure:
said frame or frames is/are divided into intermediate coding units of chosen maximum size, each intermediate coding unit of maximum size covering a set of first coding units within the first coding structure,
a) for each intermediate coding unit of maximum size, and based on prediction data of the first coding units covered by said intermediate coding unit of maximum size, the dissimilarity metric or metrics respectively associated with each of the elements of a set of predetermined partitions of said intermediate coding unit of maximum size is/are evaluated in a predetermined order,
b) for each intermediate coding unit (uci), said intermediate coding unit (uci) is formed by assigning to said intermediate coding unit the first partition among said first set of predetermined partitions (P) for which the one metric or a proportion greater than a chosen non-zero value of associated dissimilarity metrics is less than the predetermined threshold if said first partition exists,
c) if said first partition does not exist for said coding unit of maximum size, said intermediate coding unit is subdivided into n intermediate coding units of a size strictly smaller than said chosen maximum size, and
d) steps a), b), and c) are repeated for each newly formed intermediate coding unit until intermediate coding units having a predetermined minimum size are obtained.

This algorithm allows obtaining an intermediate coding structure in a simple and reliable manner, and results in a second coding structure that makes more efficient use of its correlation with the intermediate coding structure so created. In addition, this algorithm constructs intermediate coding units in a manner that can be fully parallel, meaning that the different intermediate coding units can be constructed in parallel with one another, for example via one or more processors or via a multi-core processor.

In one particular embodiment, said set of predetermined partitions comprises at least one partition into m regions of sizes strictly smaller than the size of the intermediate coding unit in question, a dissimilarity metric being associated with each of said in regions.

According to another aspect of the invention, the dissimilarity metric between the motion vectors of the first coding units is expressed in the form \sqrt{σₓ²+σ_{y}²}, said dissimilarity metric being determined as less than said predetermined threshold when the relation \sqrt{σₓ²+σ_{y}²}≦T is satisfied, where σₓ and σ_{y} are standard deviations estimated for all components of the motion vectors of the first coding units respectively in a horizontal direction and in a vertical direction of the frame comprising said coding units, and T is said predetermined threshold.

The metric thus defined and its evaluation are thus simple and reliable, which contributes to reducing the computing power required for implementing the method according to the invention.

In one particular embodiment, the motion vectors of some or all of the first coding units each point to a reference frame, and the determination of whether the first condition is satisfied occurs only if a second condition is satisfied, the second condition being whether the motion vectors of the first coding units in question point to the same reference frame.

This again reduces the computing power required, as the evaluation of the dissimilarity metric is only carried out if the second condition so defined is satisfied. In addition, it compares only those vectors that are likely to be similar.

According to another aspect of the invention, the motion vectors of some or all of the first coding units each point to a reference frame, at least one weighted motion vector based on a motion vector of said first coding unit and the time interval between the frame of the first coding unit in question and the reference frame pointed to by said motion vector is constructed for at least one of said first coding units, and the dissimilarity metric associated with one or more coding units covered by the intermediate coding unit in question is determined from one or more weighted motion vectors.

In one particular embodiment, the frames of video data are associated with two reference lists of frames to which one and/or the other of the motion vectors of the coding units link, and the verification of the first condition, or when applicable the second condition, is only analyzed if a third condition is satisfied, the third condition being whether the motion vectors of the corresponding first coding units point to reference frames belonging to the same list or lists.

This improves the transcoding speed, as the first or second condition is only evaluated if it has been previously determined that such an evaluation is indeed relevant.

In one embodiment, the analysis of the first condition, the second condition, and/or the third condition is only carried out if a fourth condition is satisfied, the fourth condition being whether the prediction data of the corresponding first coding units all comprise at least one motion vector.

This improves the encoding speed, as these conditions are evaluated only in cases where the coding units in question are encoded in an Inter encoding mode, meaning an encoding based on one or more reference frames.

In one particular embodiment, during the re-encoding step, the frame or each frame is divided into second coding units of chosen maximum size, and for each second coding unit of maximum size, said second coding unit of chosen maximum size is encoded according to the following scenarios:
e) if the co-located intermediate coding unit, where co-located means covering the same region of the frame, in the intermediate coding structure does not comprise an intermediate coding unit of strictly smaller size, said second coding unit is encoded using a partition chosen from a second predetermined set of partitions based on the partition of the co-located intermediate coding unit, said set not including a subdivision of said second coding unit into second coding units of strictly smaller size, said chosen partition minimizing a chosen coding cost function,
f) if the co-located intermediate coding unit comprises intermediate coding units of strictly smaller size, a third predetermined set of partitions and at least one subdivision of said second coding unit into second coding units of strictly smaller sizes are considered, the coding structure is determined among said third set of partitions and said at least one subdivision which provides a minimum value of said coding cost function, and:
   if said coding structure is a partition in the third set of partitions, the intermediate coding unit is encoded according to said coding structure,
   if said coding structure is the or one of said at least one subdivision into second coding units of strictly smaller sizes, steps e) and f) are applied to each of the second coding units of strictly smaller size, until considering second coding units having a minimum size determined from the size of the co-located intermediate coding units.

This limits the complexity of the transcoding method, as the partitions of the second coding units are limited by the partitions of the intermediate coding units. In addition, the coding structure of each second coding unit is thus constructed from a limited number of possible coding structures, which reduces the complexity of the encoding.

In one embodiment, the second format is HEVC format, and the first format is AVC format or MPEG-2 format.

The invention also relates to a computer program characterized in that it comprises instructions for implementing the method defined above, when this program is executed by a processor.

In addition, the invention relates to a transcoding module adapted to transcode a bitstream containing video data in a first format into a bitstream containing video data in a second format, the video data comprising frames, said frames being divided in the first format into first coding units each covering a region of the frame and defining a first coding structure for each frame, and being divided in the second format into second coding units defining a second coding structure for each frame, the module comprising:
a decoding module adapted to decode the bitstream, providing decoded video data, data representative of the first coding structures and, for each of the first coding units, prediction data, the prediction data of at least one coding unit comprising a motion vector, and
a re-encoding module adapted to encode the decoded video data in the second format,
   characterized in that the re-encoding module is configured for:
constructing, for at least one frame of video data, an intermediate coding structure comprising intermediate coding units each constructed to correspond to the merging of one or more first coding units covered by said intermediate coding unit when a first condition is satisfied, the first condition being whether a dissimilarity metric between the first coding unit or units in question and determined from motion vectors of said first coding units is less than a predetermined threshold, at least one intermediate coding unit corresponding to the merging of at least two first coding units,
assigning, to each of the intermediate coding units, prediction data constructed from prediction data of the first coding unit or units merged to form said intermediate coding unit, and
re-encoding the decoded video data in the second format by constructing the second coding structure based on the intermediate coding structure.

Finally, the invention relates to a telecommunications device comprising an interface for receiving a bitstream containing video data in a first format, characterized in that it comprises a transcoding module as defined above.

The invention will be better understood by reading the detailed description that follows, given solely by way of example, and provided with reference to the appended Figures in which:

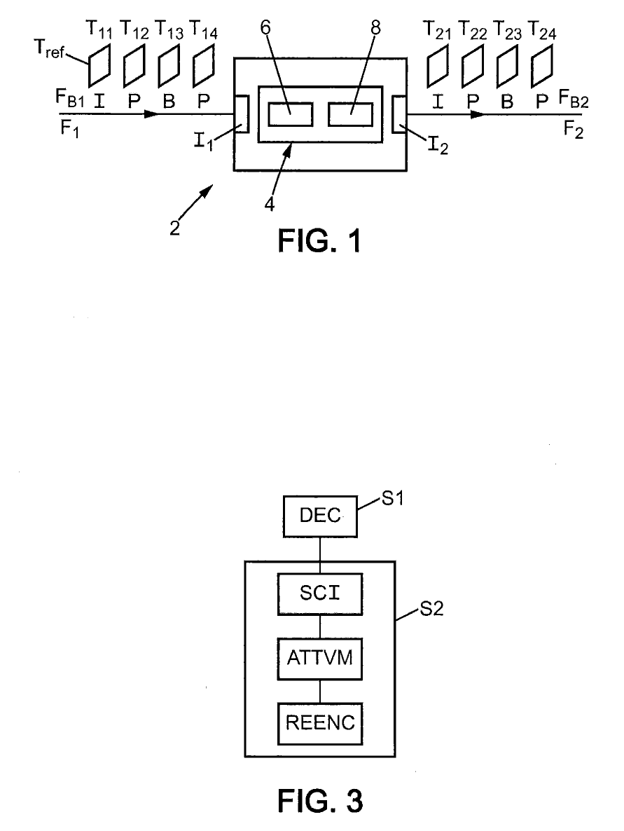

FIG. 1 is a schematic illustration of a telecommunications device and a transcoding module according to the invention;

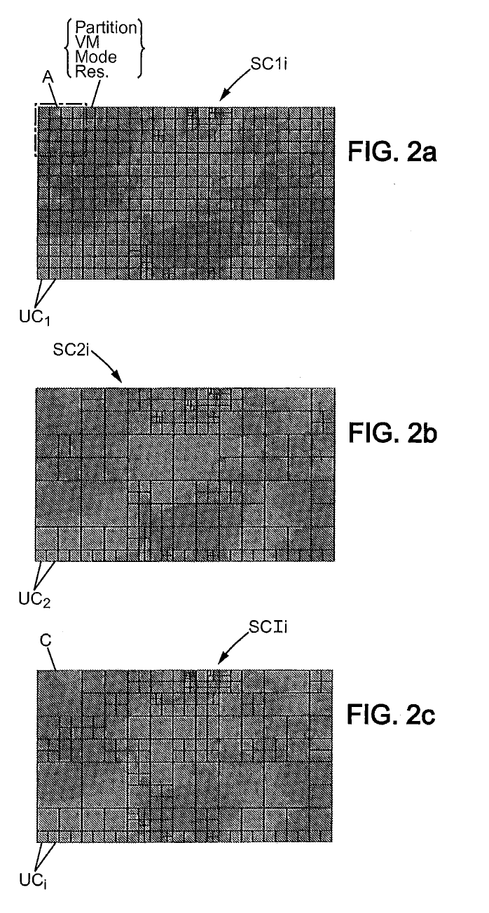

FIGS. 2a to 2c illustrate coding structures of a frame of video data;

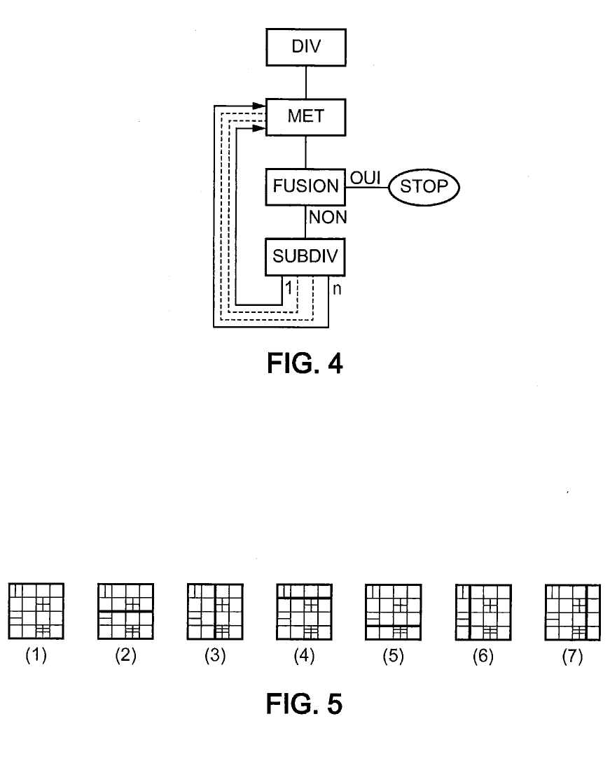

FIGS. 3 and 4 illustrate a transcoding method according to the invention; and

FIG. 5 illustrates a first set of possible partitions of an intermediate coding unit constructed during the method of the invention.

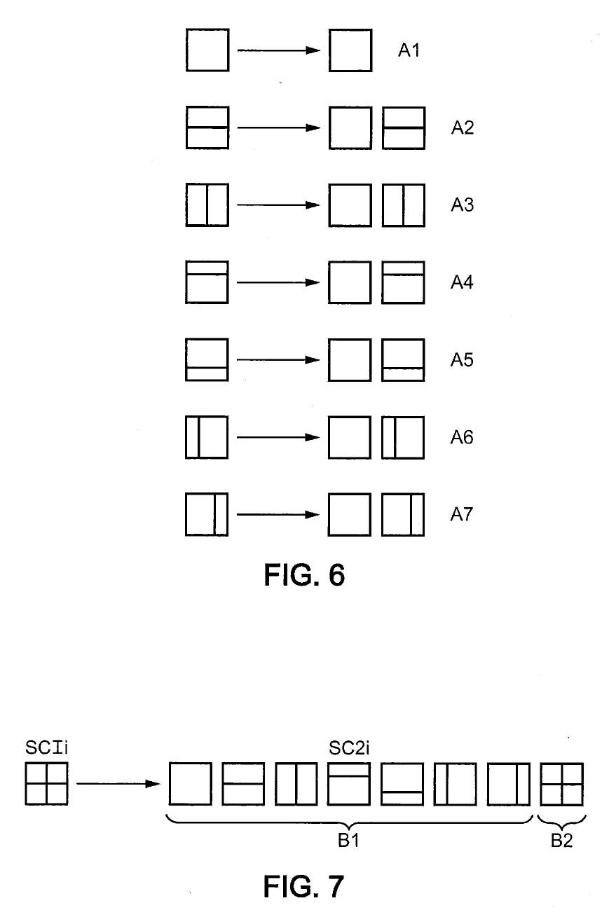

FIG. 6 illustrates second sets of partitions of a second coding unit constructed during the method of the invention; and

FIG. 7 illustrates a third set of partitions and a subdivision of a second coding unit constructed during the method of the invention.

FIG. 1 illustrates a telecommunications device 2 of the invention, referred to hereinafter as device 2.

The device 2 comprises a first interface I1 adapted to receive a bitstream FB1 of video data in a first format F1 and a second interface I2 adapted to provide a bitstream FB2 of video data in a second format F2 to another device to which device 2 is connected. In addition, device 2 comprises a transcoding module 4 according to the invention.

Device 2 is, for example, a member of the group composed of: a computer, a mobile phone, a touch pad, a television, a router, a device adapted for connection to other Internet devices, and a data storage module.

The transcoding module 4 is configured to convert the bitstream FB1 in the first format F1 into the second bitstream FB2 in the second format F2.

Preferably, the two formats F1 and F2 are distinct from one another.

In addition, preferably the second format F2 is HEVC format, the acronym for “High Efficiency Video Coding.” HEVC is a standard intended to replace AVC, the acronym for “Advanced Video Coding” and also known as H.264/MPEG-4 AVC. Furthermore, preferably the first format is AVC format or MPEG-2 format (“Moving Pictures Expert Group-2”). Other formats are possible, however, for the first and second formats, the conditions governing the applicability of the invention being provided below.

Generally, video data are organized into frames, or images. These frames comprise a set of pixels which are associated with chrominance and luminance values which are output by a display device in order to display the frames. Also, many encoding formats are designed to encode all this information not as raw data but by using predictive methods which restore the content of sub-portions of the frames based on the content of other regions in the same frame or different frames.

Specifically, we distinguish between “Intra” predictions which are based on spatial predictions of the content of a region of a frame from the content of another region of the same frame, and “Inter” predictions which are based on a temporal prediction of the content of regions of a frame from the content of a region of one or more other frames.

These Inter or Intra types of prediction can be applied to an entire frame, or selectively for certain regions of a frame, other regions of the frame having a different type of prediction.

Note that we distinguish between:
I or Intra frames, which contain only Intra-encoded coding units,
P or Inter frames, which contain or consist of coding units predicted from a previously encoded frame, and
B or bi-directional frames, which contain or consist of coding units predicted from two previously encoded frames.

In some formats such HEVC, this distinction is applied at a more detailed level than the frame: the frames are divided into slices, each slice being of type I, P, or B.

Referring to FIGS. 2a to 2c, the frames are more specifically organized into coding units which each correspond to a region of the frame and define a coding structure for each frame. Note that the frames are labeled by indexes 1i and 2i, the integer indicating the format, two frames of the same index i corresponding to the same image but not being exactly identical due to their respective encoding in different formats.

FIG. 2a illustrates a coding structure of a frame T₁ᵢ in the first format F1, hereinafter the first coding structure SC1i.

The first coding structure SC1i of frame T1i comprises a plurality of first coding units uc1 each corresponding to a region of the frame. In practice, the region of the frame covered by a coding unit uc1 is defined by data providing for example the first pixel that the coding unit contains and the dimensions of the coding unit.

Each coding unit uc1 further comprises a given size between a maximum size t1ₘₐₓ and a minimum size t1ₘᵢₙ. The sizes of coding units are in pixels by pixels. The maximum and minimum sizes are for example predetermined sizes, for example determined by the standard defining the first format F1, or preferred sizes, for example when the standard does not impose a size constraint. For example, the maximum size in AVC is imposed by the standard and is 16 pixels by 16 pixels. In addition, in HEVC the standard does not dictate a maximum size, but a maximum size commonly used is 64 pixels by 64 pixels.

Each coding unit uc1 may comprise strictly smaller coding units. In other words, a given coding unit may cover a portion of a frame that is divided into coding units of smaller sizes. For example, a coding unit may comprise four smaller coding units.

The first coding units uc1 composed of smaller coding units are associated with data defining the subdivision of this coding unit in these smaller coding units.

Each coding unit uc1 that is not subdivided, meaning it contains no strictly smaller coding units, is associated with a coding mode, partition information, prediction data, and a residue.

More specifically, the coding mode corresponds to information indicating the prediction mode used for the coding unit. For example, the prediction mode is Intra mode or Inter mode. Some formats provide other prediction modes, such as SKIP mode in AVC or MERGE mode in HEVC. In the latter mode, the motion vector is not estimated in the conventional manner but is constructed by a function called by the declaration of MERGE mode and which provides the motion vector of a spatiotemporally neighboring coding unit chosen from a set of candidate neighboring coding units.

The partition information is representative of the partitioning or non-partitioning of the coding unit into smaller regions.

More specifically, a partition consists of:
a single region, in which case the region covers the entire coding unit and has the same size, or
two or more regions, in which case each region covers a smaller area of the frame than the coding unit in question.

Note that the term “regions” rather than “coding unit” is used here and below, because these regions generally do not correspond to a coding unit in the strict sense. In particular, each region of a partition is associated with prediction data which, in the case of an Inter coding mode of the partitioned coding unit, corresponds to motion parameters, but not a coding mode or a residue. In addition, regions may have a non-square shape, for example rectangular or some other shape, unlike coding units which do indeed have a square shape.

The above motion parameters more specifically comprise one or two motion vector(s) VM and one or two respective indexes described below. For example, such regions are known in certain formats such as HEVC by the name “Prediction Unit.”

The prediction data are associated with the region or regions from which the content of the coding unit is constructed by prediction. The content of the prediction data is therefore based on the prediction type (Inter or Intra) used for the coding unit.

In the case of Inter coding, the prediction data comprise at least one motion vector VM for predicting the content of the coding unit from another frame T_{ref} called the reference frame, and an index of the reference frame T_{ref} in a list of reference frames described below. The prediction data of the first coding units comprise either a motion vector VM and the associated index of the reference frame T_{ref} in the case of a P-type prediction, or two motion vectors and the respective indexes of two reference frames in the case of a B-type prediction.

More specifically, the prediction data for an Inter-encoded coding unit comprise at least one motion vector VM per region of the partition of this coding unit.

In the case of Intra coding, the prediction data correspond to a prediction direction from which the content of the coding unit in question is constructed. Note that prediction directions may be known as “directional modes.”

In some formats, each frame is associated with one or two reference lists. These reference lists comprise indexes identifying the frames from which the frame regions in question are predicted. The reference lists respectively associated with two separate frames may be identical or different. Also note that in the case of Inter prediction of a coding unit in a B-type frame, the prediction data of this coding unit may include, for each region, two motion vectors VM and two indexes of two reference frames, each belonging to a list.

The residue corresponds to the difference between the original content of the region of the frame covered by the coding unit and the result of the prediction of the coding unit. The residue, after transformation and quantization, is to be added to the result of the prediction in order to determine the final content of the corresponding region of the frame. In some coding modes, the residue information may be empty, in which case the residue is in practice not encoded, the reconstruction of the corresponding coding unit being done solely on the basis of prediction of its content.

FIG. 2b illustrates the coding structure of the same frame T₂ᵢ in the second format F2, or second coding structure SC2i. The second coding structure SC2i comprises second coding units uc2 each having a given size between a maximum size t2ₘₐₓ and a minimum size t2ₘᵢₙ. For example, the maximum sizes t1ₘₐₓ and t2ₘₐₓ and/or the minimum sizes t1ₘᵢₙ and t2ₘᵢₙ are different.

The second coding units uc2 that do not comprise second smaller coding units are also associated with prediction data, a coding mode, and a residue.

In addition, the first coding units uc1 and/or second coding units that do not comprise strictly smaller coding units may however be partitioned into regions that are not themselves coding units strictly speaking but which have one or two motion vectors VM associated with each region of the partition.

Also note that coding units of a given format may be known by a specific name. For example, in the AVC format, coding units are known as “macroblocks” (MB). In the HEVC format, coding units can have various names and be of varying types. For example, there are Coding Tree Units (CTU) which correspond to the AVC macroblocks MB (with a maximum size that may be different from that of the macroblocks MB), and Coding Units (CU).

Referring to FIG. 1, the transcoding module 4 comprises a decoding module 6 and a re-encoding module 8.

The decoding module 6 is adapted to decode the bitstream FBI having the first format F1. This decoding supplies the decoded video data (using the residue encoded in the bitstream FBI), data representative of the first coding structure of the frames, and for some or all of the first coding units, the coding mode, the partition information, and associated prediction data.

Note that the prediction data of at least a first coding unit preferably comprise a motion vector VM, which indicates that at least one coding unit is not encoded with Intra prediction.

As for the re-encoding module 8, it is adapted to encode the decoded video data in the second format.

The transcoding module 4 is more specifically configured for implementing the transcoding method detailed below.

During a step S1, the video data contained in the bitstream FBI in the first format 1 are decoded. As indicated above, this decoding provides the decoded video data, as well as the first coding structure of the different frames Tᵢ₁ and the data associated with each of the first coding units uc1, including the coding mode, the partition information, and the associated prediction data.

During a step S2, the video data are re-encoded in the second format F2.

To do this, according to the invention, for at least one frame of video data, an intermediate coding structure SCIi comprising intermediate coding units uci is constructed. Each intermediate coding unit is constructed from the first coding structure SC1i and corresponds to the merging of one or more first coding units uc1 covered by said intermediate coding unit uci when a first condition C1 is met. The construction of the intermediate structure SCIi is described in more detail below. The first condition C1 is satisfied when at least one dissimilarity metric D associated with the first coding unit or units uc1 in question, in other words corresponding to the same region of the frame, and determined from motion vectors VM of said first coding units, is less than a predetermined non-zero threshold T.

For example, the chosen metric D is expressed as \sqrt{σₓ²+σ_{y}²,}, where σₓ and σ_{y} are standard deviations estimated for all components of the motion vectors VM of the first coding units uc1 in question respectively in a horizontal direction and in a vertical direction of the frame comprising said coding units. In other words, the metric D is constructed as the square root of the sum of the variance of the horizontal components of the motion vector(s) VM in question and of the variance of the vertical components of these motion vectors VM.

One will note here that when evaluating the metric D for one motion vector, this metric is zero.

Preferably, at least one intermediate coding unit uci corresponds to the merging of at least two first coding units.

In addition, the precise value of the threshold T is determined based on criteria known to the skilled person such as the desired compromise between the reduction in complexity of the transcoding and the obtained reconstruction quality which the data encoded in the second format must satisfy. This compromise, for example, varies from one application to another, for example such as video conferencing, video editing, etc.

With reference to FIGS. 2c and 4, the actual construction of the intermediate coding structure SCI is performed iteratively as follows.

Initially, in a step DIV, the frame in question is divided into intermediate coding units uci of a chosen maximum size tiₘₐₓ, each intermediate coding unit uc1 of maximum size tiₘₐₓ covering an area of the frame covered by a set of first coding units within the first coding structure SC1i. In other words, with reference to FIGS. 2a and 2c, area C corresponds to the first region of the frame in question. In the intermediate coding structure SCIi, this area C corresponds to an intermediate coding unit. This area C also corresponds to the area A (surrounded by dashed lines) in FIG. 2a which is covered by a certain number (in this case 16) of first coding units uc1. Note that areas A and C are said to be “co-located” relative to one another, meaning that they both cover the same region of the same frame.

The maximum size tiₘₐₓ can be chosen to have any value. Preferably, however, tiₘₐₓ, chosen based on the maximum size t2ₘₐₓ of the second coding units.

During a step MET, for each intermediate coding unit uci of maximum size tiₘₐₓ, and based on prediction data of the first coding units uc1 covered by said intermediate coding unit uci, the dissimilarity metrics D respectively associated with each of the elements of a first set of partitions P1 of the coding unit in question are evaluated in a predetermined order.

FIG. 5 illustrates an example of a set PI containing 7 partitions: 1 partition covering the entire coding unit in question, 3 horizontal partitions of which two are asymmetric, and 3 vertical partitions of which two are asymmetric. In practice, the partitions in the set PI in question for a given coding unit uci are determined based on characteristics of the second format F2, such as the maximum size t2ₘₐₓ or the partitions allowed for the coding units of this format F2.

Note that each intermediate coding unit uci is associated with a single dissimilarity metric D or multiple dissimilarity metrics, depending on the partition of this intermediate coding unit that is currently being evaluated. For example, each partition is associated with a number of metrics equal to the number of regions of the coding unit that are defined by this partition.

In a merge step FUSION, each intermediate coding unit uci is constructed by assigning to said intermediate coding unit the first partition in said set of predetermined partitions for which the single associated metric or a proportion higher than a chosen non-zero value of associated metrics D is less than the predetermined threshold if said first partition exists.

This chosen value is a percentage for example, 75% for example. However, this proportion is preferably 100%. In other words, if the associated metric or each of the associated metrics D is less than T, the coding units covered by the intermediate coding unit in question are merged by assigning partition (1) to this intermediate coding unit, and processing of the coding unit in question is ended. This also reduces the complexity of the transcoding while limiting the associated loss of quality. The rest of the description continues with this value being equal to 100%.

Referring to FIG. 5, in other words the metric(s) D associated with the entire coding unit (1) is/are calculated. In this example, partition (1) is associated with a single metric. Also, if the associated metric is less than T, the coding units covered by the intermediate coding unit in question are merged by assigning partition (1) to this intermediate coding unit, and processing is ended for the coding unit in question.

Here, if the metric of partition (1) is not less than T, the metric(s) of partition (2) is/are evaluated (for example, one metric is associated with each of the two regions of partition (2)). In the case where the chosen value is equal to 100%, if the metrics are both less than T, the intermediate unit is assigned partition (2). If such is still not the case, the process continues until consideration of partition (7).

If said first partition does not exist, in other words none of the partitions of set P1 leads to a metric or metrics all less than T, said intermediate coding unit is subdivided into n intermediate coding units of a size strictly smaller than said chosen maximum size. For example, the coding unit is subdivided into 4 smaller coding units. Then the above steps are repeated for each intermediate coding unit thus formed, possibly until considering intermediate coding units having a predetermined minimum size tiₘᵢₙ. Note that this minimum size tiₘᵢₙ may be different from minimum size t1ₘᵢₙ. In fact, for reasons described hereinafter, preferably the minimum size tiₘᵢₙ is chosen to correspond to the minimum size t2ₘᵢₙ of the second coding units uc2.

Once this minimum size is reached (if such is the case), the metric or metrics D respectively associated with each of the partitions of the set P1 associated with the intermediate unit of minimum size in question is/are also evaluated, and the intermediate coding unit is assigned the first partition of set P1 whose one metric or a proportion greater than the chosen value of the associated metrics D is less than T.

However, if none of these partitions satisfy this condition, the coding unit is assigned an arbitrary partition. For example, this arbitrary partition is the partition of the intermediate coding unit into a single region of a size identical to that of the coding unit itself.

The intermediate coding structure SCIi of the entire frame is thus constructed. Note that the construction of an intermediate coding unit uci is independent of the construction of another intermediate coding unit. This construction is thus fully achievable in parallel, meaning that the various intermediate coding units can be constructed in parallel to each other, for example via one or more processors or via a multi-core processor.

In some embodiments, for the construction of at least one intermediate coding unit, determination of whether the first condition is C1 satisfied is carried out only if a second condition C2 is previously satisfied. This second condition C2 concerns the reference frames linked to by the motion vectors of the corresponding first coding units. More specifically, the second condition C2 is satisfied when the motion vectors of the first coding units in question (meaning covered by the intermediate coding unit in question) point to the same reference frame T_{ref}. The introduction of this condition makes it possible to increase the encoding speed by eliminating the calculation of the metric(s) for situations in which analysis of the dissimilarity of the motion vectors in question has little or no relevance in principle.

For example, the analysis of condition C2 and whether it is satisfied is performed for each partition of set P1 prior to calculating the metric(s) associated with the partition in question.

If condition C2 is not satisfied, condition C1 is considered as not satisfied for the coding unit in question, without calculating the associated metric(s).

Preferably, the second condition C2 is satisfied when constructing at least one intermediate coding unit uci.

In addition, in some embodiments, during construction of the intermediate coding structure SCIi, for at least one first coding unit uc1 at least one weighted motion vector is constructed based on a motion vector VM of this coding unit and the time interval between the frame of the first coding unit in question and the reference frame T_{ref} pointed to by said motion vector. Indeed, in known manner, the reference frame associated with the motion vector can be characterized by the time interval between the frame of the unit in question and the reference frame T_{ref}. Also, for example, a weighted motion vector is constructed by dividing each component of the motion vector by a factor determined from this time interval.

Following this, in the construction described above, the similarity metric associated with one or more coding units covered by the intermediate coding unit in question is determined from one or more weighted motion vectors so constructed.

This principle of constructing weighted motion vectors is known by the term “scaling.” In practice, this principle makes it possible to construct, within a coding unit, motion vectors which all point to the same reference frame. In the method of constructing an intermediate coding unit which covers first coding units scaled in this manner, the second condition C2 is no longer relevant and so its analysis is not performed.

Moreover, in some embodiments, verification of whether the first condition C1, or the second condition C2 when applied, is satisfied only occurs if a third condition C3 is satisfied. This third condition C3 relates to whether the motion vectors of the first coding units corresponding to the intermediate coding unit in question point to reference frames belonging to the same reference list(s). This also limits the cases where the metric T is actually calculated.

As above, this condition C3 is analyzed for each partition of the set IP in question, prior to calculating the associated metric(s). If this condition C3 is not satisfied, condition C1 is considered as not satisfied, in other words at least one of the metrics associated with the coding unit in question is not strictly less than T, and this occurs without actually calculating this or these metrics.

Note that in the case where condition C3 is satisfied and the first coding units comprise motion vectors pointing to frames belonging to both of the two reference lists, the intermediate coding unit in question is associated with one or more metrics D for each of these two lists. Thus, for example, each partition is associated with a number of metrics equal to the number of regions of the coding unit defined by this partition, and this is true for each reference list pointed to by the associated prediction data.

In addition, in some embodiments, analysis of the first condition C1, the second condition C2, and/or the third condition C3 is only performed if a fourth condition C4 is met. This fourth condition C4 is satisfied when the prediction data of the corresponding first coding units all comprise at least one motion vector. In other words, analysis of condition C1 and, where appropriate, of condition C2 and/or condition C3 in the corresponding embodiments, is carried out only if the first coding units covered by the intermediate coding unit uci in question are all predicted by Inter prediction, and not by Intra prediction.

If this condition C4 is not satisfied, condition C1 is considered as not satisfied for the coding unit in question, without actually calculating the associated metric(s).

Note that the embodiments introducing conditions C2, C3, and C4 can be combined naturally, as implied in the description above. Any possible combination of these embodiments may be implemented in the context of the invention. In addition, the use of weighted motion vectors can be achieved by replacing condition C2 for a given coding unit, and vice versa.

After the construction of each intermediate coding unit uci of the intermediate coding structure SCIi, each of the intermediate coding units uci is assigned prediction data constructed from prediction data of the first coding unit(s) used to form said intermediate coding unit. For example, the prediction data are taken as being equal to the prediction data of the only or of the first of the first coding units that cover(s) the intermediate coding unit uci in question. In practice, a motion vector is thus assigned to the intermediate coding unit uci constructed as described above.

The intermediate coding structure SC1i of the frame in question is thus obtained, for each frame for which such a coding structure is desired. Preferably, an intermediate coding structure is constructed for each frame of video data.

Once the intermediate coding structures are constructed, the decoded video data are re-encoded in the second format F2 by constructing the second coding structure SC2i of the frames for which an intermediate coding structure SCIi was constructed, based on the corresponding intermediate coding structure SCIi.

To do this, the frame or each of these frames is/are divided into second coding units uc2 of chosen maximum size t2_{maxc}. This size may be less than or equal to the maximum size t2max. For example, these two sizes are chosen as equal, which tends to provide better encoding speed.

Then, for each second coding unit uc2 of maximum size t2_{maxc}, said chosen second coding unit of maximum size is encoded according to whether the co-located intermediate coding unit comprises intermediate coding units of strictly smaller size.

If the co-located intermediate coding unit uci in the intermediate coding structure comprises no intermediate coding unit of strictly smaller size, said second coding unit is encoded using a partition chosen from a predetermined second set of partitions P2 based on partitioning the co-located intermediate coding unit into one or more regions, said set not including a subdivision of said second coding unit into second coding units of strictly smaller size, said partition being chosen as the partition providing a minimum value of a coding cost function J among the partitions of said set of partitions.

FIG. 6 shows examples of sets of partitions P2. The sets of partitions P2 are respectively associated with a given partition of the co-located intermediate coding unit when this co-located intermediate unit is or is not partitioned into regions but is not divided into coding units of smaller sizes. The set P2 illustrated by subgroup A1 corresponds to a case where the intermediate coding unit is not partitioned into smaller regions, subgroups A2 to A7 correspond to sets of partitions P2 for second coding units where the co-located intermediate coding unit is partitioned into smaller regions (but, as indicated above, this unit is not divided into coding units of smaller size).

In addition, for example, the coding cost function J is expressed in the form:

J=D+λR

where D is a distortion parameter, R is a bitrate parameter, and λ is a weighting coefficient.

The partition among all those of the associated set P2 that yields the smallest value for function J among all partitions is thus chosen for the coding unit.

Conversely, if the co-located intermediate coding unit comprises intermediate coding units uci of strictly smaller size, a third predetermined set of partitions P3 and at least one subdivision of said second coding unit into second coding units (uc2) of strictly smaller size are considered.

FIG. 7 illustrates an exemplary set of partitions P3 (subgroup B1), and an exemplary subdivision into smaller coding units (subgroup B2). For example, this subdivision is identical to the subdivision of the co-located intermediate coding unit into intermediate coding units of smaller sizes.

Preferably, the third set of partitions comprises the set of possible partitions of a coding unit which are allowed by format F2.

In addition, preferably, the second set of partitions P2 is a strict subset of the third set of partitions P3. Thus, for example, the second set P2 comprises a partition into the coding unit itself, and a partition identical to the partition of the co-located intermediate coding unit. This reduces the complexity of the transcoding method according to the invention by limiting the number of partitions for which the coding cost function J is calculated.

Next, among said third set of partitions P3 and said at least one subdivision, the coding structure that provides a minimum value for said coding cost function (J) is determined. The coding structure is therefore either a partition of set P3, or the or one of the proposed subdivision(s).

The rest of the construction of the second coding unit diverges according to the result.

If said coding structure that minimizes the coding cost function J is a partition in the third set of partitions P3, the intermediate coding unit is encoded by assigning it the coding structure, in other words the partition in question.

However, if said coding structure is the or is one of said at least one subdivision into second coding units of strictly smaller sizes, the second coding unit is assigned the corresponding subdivision and then one proceeds iteratively by considering each of the second coding units of this subdivision as a coding unit to which the above steps are applied, eventually reaching second coding units whose size is the minimum size of the co-located intermediate coding units.

Thus, for each of the coding units of the subdivision, it is once again determined whether the co-located intermediate coding unit comprises coding units of strictly smaller size. If such is not the case, the coding structure of the unit in question is determined from the associated set of partitions P2 which itself is determined based on the possible partitioning of the co-located intermediate coding unit. If the unit again comprises smaller coding units (and not just regions of partitions, as indicated above), it is determined whether the coding structure of the coding unit that minimizes the coding cost function is a partition, in which case it is assigned this partition as a coding structure, or is a subdivision into coding units of even smaller sizes in which case this subdivision is applied to the coding unit and the above steps are repeated for the coding units of the newly formed subdivision.

The method according to the invention has the major advantage of greatly limiting the coding structures which are tested, in other words for which the relevance is evaluated, in order to determine the second coding structure of a second coding unit. During the implementation of the method, the different partitions of a given second coding unit are tested by iteration at a given coding unit size, and over a small population of possible partitions of this coding unit for each iteration. In other words, the tests are performed by progressively incrementing the level of granularity considered, each level of granularity incurring a small number of tests. In addition, the number of iterations is restricted because it is built on the subdivision or non-subdivision of the co-located coding unit into smaller coding units. The complexity of the transcoding according to the invention is therefore further decreased, in particular compared to the FD-FE principle where the tests cover all possible combinations of partitions of a coding unit and its subdivisions.

Note that in the above description, the term “coding structure” is used for a frame but also for coding units. In the latter case, the term “coding structure” is understood to mean “local coding structure”, which in practice means the dividing of units into smaller coding units and/or into partition regions.

This re-encoding step thus provides a bitstream in the second format F2. This bitstream is sent to another device via the second interface I2, or is stored on the device 2.

Note also that the transcoding module 4 is, for example, a software module. The invention thus also relates to a computer program comprising instructions for implementing the above method when the program is executed by a processor.

Alternatively, the transcoding module 4 is a hardware module. For example, in the corresponding embodiments, the transcoding module 4 is in the form of a chipset type of integrated circuit.

The inventors have implemented the method according to the invention for AVC-HEVC transcoding of nineteen reference video sequences (comprising 150 to 600 frames each) and have compared the obtained results to the FD-FE method and to various methods of the prior art.

Transcoding time was reduced by an average of 58% compared to the FD-FE method, with an average increase in bitrate (at constant quality) of 2.4%. The results are better than those from methods of the prior art in a random-access configuration and are comparable in a low-delay configuration (in other words in real time).

The transcoding method according to the invention is applicable to all formats that provide a structuring of frames into coding units, these coding units being associated with prediction data indicating an Inter or equivalent type of coding, in other words based on predicting the contents of a frame from the contents of one or more other frames.

However, the invention is particularly suitable for transcoding between a first format F1 and a second format F2 for which the maximum size t2ₘₐₓ is greater than size t1ₘₐₓ. In addition, the invention is particularly suitable for formats that provide for partitioning coding units into regions. Indeed, for such formats, the reduction in complexity offered by the invention is even more tangible as it limits the number of coding structures tested for the construction of coding units of the target format (format F2).

In addition, in the context of the transcoding method according to the invention, preferably the minimum size tiₘᵢₙ is greater than or equal to the minimum size t1ₘᵢₙ. The first coding units uc1 are merged to form the intermediate coding units, the merge algorithm resulting in merging the first coding unit with itself when the size of the intermediate coding units corresponds, in the worst case, to the minimum size of the first coding units. In this case, the associated metric(s) is/are calculated from a single motion vector, and are therefore zero. The algorithm therefore cannot yield an intermediate coding unit smaller than the minimum size of the first coding units.

When tiₘᵢₙ is strictly greater than t1ₘᵢₙ, and as described above, it is possible that no tested partition is suitable, in which case the intermediate coding unit of minimum size in question is assigned an arbitrary partition, for example a partition into the unit itself.

Furthermore, preferably, maximum size tiₘₐₓ is greater than or equal to maximum size t1ₘₐₓ. One of the means by which the invention reduces the complexity of transcoding between the two formats is the reduction in the complexity of the local coding structure, in other words the construction of local coding structures that are possibly less subdivided. Failure to observe this relationship would thus render this reduction of subdivisions impossible, and would therefore reduce the benefits of the invention.

Furthermore, preferably, maximum size t2ₘₐₓ is greater than or equal to maximum size tiₘₐₓ. Due to the principle of limiting the complexity of the local structure of the second coding units that is applied during their construction via the method of the invention, a second coding unit has a local coding structure that is as partitioned and/or subdivided as the co-located intermediate coding unit. However, it is desirable to be able to have second coding units with a less complex coding structure than that of the co-located intermediate coding unit, and therefore larger. In such cases, in practice the intermediate coding units co-located at these second coding units are considered to be subdivided (diagram of FIG. 7).

In addition, preferably, size t2ₘᵢₙ is greater than or equal to size tiₘᵢₙ. The algorithm for constructing second coding units cannot yield a second coding unit smaller than tiₘᵢₙ because the intermediate coding units of minimum size are by definition not subdivided. The second coding unit co-located in an intermediate coding unit of minimum size therefore cannot itself be subdivided.

Other embodiments are also possible.

1. A method of transcoding a bitstream (FBI) containing video data in a first format (F1) into a bitstream (FB2) containing said video data in a second format (F2), the video data comprising frames (T1i, T2i), said frames being divided in the first format into first coding units (uc1) each covering a region of the frame and defining a first coding structure (SC1i) for each frame, and being divided in the second format (F2) into second coding units (uc2) defining a second coding structure (SC2i) for each frame, the method comprising:
a bitstream decoding step providing decoded video data, data representative of the first coding structure (SC1i) of the frames and, for some or all of the first coding units (uc1), prediction data, the prediction data of at least one first coding unit (uc1) comprising a motion vector (VM), and
a re-encoding step during which the decoded video data are encoded in the second format (F2),
characterized in that during the re-encoding step, for at least one frame of the decoded video data:
an intermediate coding structure (SCIi) is constructed, comprising intermediate coding units (uci) each constructed to correspond to the merging of one or more first coding units (uc1) covered by said intermediate coding unit when a first condition (C1) is satisfied, the first condition being that at least one dissimilarity metric (M) associated with the intermediate coding unit in question and determined from the motion vectors of said first coding units is less than a predetermined threshold (T), at least one intermediate coding unit (uci) corresponding to the merging of at least two first coding units (uc1),
each of the intermediate coding units (uci) is assigned prediction data constructed from prediction data of the first coding unit or units merged to form said intermediate coding unit, and
the decoded video data are re-encoded in the second format (F2) by constructing the second coding structure (uc2) based on the intermediate coding structure (SCIi).

2. Method according to claim 1, wherein, for the construction of the intermediate coding structure:
said frame or frames is/are divided into intermediate coding units (uci) of chosen maximum size (tiₘₐₓ), each intermediate coding unit of maximum size covering a set of first coding units within the first coding structure,
a) for each intermediate coding unit of maximum size, and based on prediction data of the first coding units (uc1) covered by said intermediate coding unit (uci) of maximum size (tiₘₐₓ), the dissimilarity metric or metrics (M) respectively associated with each of the elements of a first set of predetermined partitions (P) of said intermediate coding unit of maximum size is/are evaluated in a predetermined order,
b) for each intermediate coding unit (uci), said intermediate coding unit (uci) is formed by assigning to said intermediate coding unit the first partition among said first set of predetermined partitions (P) for which the one metric or a proportion greater than a chosen non-zero value of the associated dissimilarity metrics is less than the predetermined threshold if said first partition exists,
c) if said first partition does not exist for said coding unit of maximum size, said intermediate coding unit is subdivided into n intermediate coding units (uci) of a size strictly smaller than said chosen maximum size (tiₘₐₓ), and
d) steps a), b), and c) are repeated for each newly formed intermediate coding unit until intermediate coding units having a predetermined minimum size (tiₘᵢₙ) are obtained.

3. Method according to claim 2, wherein said set of predetermined partitions comprises at least one partition into m regions of sizes strictly smaller than the size of the intermediate coding unit in question, a dissimilarity metric (M) being associated with each of said m regions.

4. Method according to claim 1, wherein the dissimilarity metric (M) between the motion vectors of first coding units is expressed in the form \sqrt{σₓ²+σ_{y}²} and is determined to be less than said predetermined threshold when the relation \sqrt{σₓ²+σ_{y}²}≦T is satisfied, where σₓ and σ_{y} are standard deviations estimated for all components of the motion vectors of the first coding units (uc1) respectively in a horizontal direction and in a vertical direction of the frame comprising said coding units, and T is said predetermined threshold.

5. Method according to claim 1, wherein the motion vectors (VM) of some or all of the first coding units each point to a reference frame (T_{ref}), and wherein the determination of whether the first condition (C1) is satisfied occurs only if a second condition (C2) is satisfied, the second condition being whether the motion vectors (VM) of the first coding units in question point to the same reference frame (T_{ref}).

6. Method according to claim 1, wherein the motion vectors (VM) of some or all of the first coding units (uc1) each point to a reference frame (T_{ref}), wherein at least one weighted motion vector based on a motion vector (VM) of said first coding unit and the time interval between the frame of the first coding unit in question and the reference frame pointed to by said motion vector is constructed for at least one of said first coding units, and wherein the similarity metric associated with one or more coding units covered by the intermediate coding unit in question is determined from one or more weighted motion vectors.

7. Method according to claim 5, wherein the frames of video data are associated with two reference lists of frames to which one and/or the other of the motion vectors of the coding units link, and wherein the verification of the first condition (C1), or when applicable the second condition (C2), is only analyzed if a third condition (C3) is satisfied, the third condition being whether the motion vectors (VM) of the corresponding first coding units point to reference frames belonging to the same reference list or lists.

8. Method according to claim 7, wherein the analysis of the first condition (C1), the second condition (C2), and/or the third condition (C3) is only carried out if a fourth condition (C4) is satisfied, the fourth condition being whether the prediction data of the corresponding first coding units (uc1) all comprise at least one motion vector (VM).

9. Method according to claim 1, wherein, during the re-encoding step, the frame or each frame is divided into second coding units (uc2) of chosen maximum size (t2_{maxc}), and for each second coding unit (uc2) of maximum size, said second coding unit of chosen maximum size is encoded according to the following scenarios:
e) if the co-located intermediate coding unit, where co-located means covering the same region of the frame, in the intermediate coding structure (SCIi) does not comprise an intermediate coding unit (uci) of strictly smaller size, said second coding unit (uc2) is encoded using a partition chosen from a second predetermined set of partitions (P2) based on the partition of the co-located intermediate coding unit, said second set (P2) not including a subdivision of said second coding unit into second coding units of strictly smaller size, said chosen partition minimizing a chosen coding cost function (J),
f) if the co-located intermediate coding unit comprises intermediate coding units of strictly smaller size, a third predetermined set of partitions (P3) and at least one subdivision of said second coding unit into second coding units of strictly smaller sizes are considered, the coding structure is determined among said third set of partitions (P3) and said at least one subdivision which provides a minimum value of said coding cost function (J), and:
if said coding structure is a partition in the third set of partitions (P3), the intermediate coding unit is encoded according to said coding structure,
if said coding structure is the or one of said at least one subdivision into second coding units of strictly smaller sizes, the second coding unit is subdivided according to said subdivision and steps e) and f) are applied to each of the second coding units of said newly formed subdivision, until considering second coding units having a minimum size predetermined from the co-located intermediate coding units.

10. Method according to claim 1, wherein the second format is HEVC format, and the first format is MPEG-2 or AVC format.

11. A computer program characterized in that it comprises instructions for implementing the method according to claim 1 when this program is executed by a processor.

12. A transcoding module adapted to transcode a bitstream (FBI) containing video data in a first format (F1) into a bitstream (FB2) containing said video data in a second format (F2), the video data comprising frames (T1i, T2i), said frames being divided in the first format into first coding units (uc1) each covering a region of the frame and defining a first coding structure (SC1i) for each frame, and being divided in the second format (F2) into second coding units (uc2) defining a second coding structure (SC2i) for each frame, the transcoding module comprising:
a decoding module (6) adapted to decode the bitstream, providing decoded video data, data representative of the first coding structures and, for some or all of the first coding units, prediction data, the prediction data of at least one coding unit comprising a motion vector, and
a re-encoding module (8) adapted to encode the decoded video data in the second format (F2),
characterized in that the re-encoding module (8) is configured for:
constructing, for at least one frame of decoded video data in the first format (F1), an intermediate coding structure (SCIi) comprising intermediate coding units (uci) each constructed to correspond to the merging of one or more first coding units (uc1) covered by said intermediate coding unit (uci) when a first condition (C1) is satisfied, the first condition being whether at least one dissimilarity metric (M) associated with the intermediate coding unit in question and determined from motion vectors of said first coding units is less than a predetermined threshold (T), at least one intermediate coding unit (uci) corresponding to the merging of at least two first coding units (uc1),
assigning, to each of the intermediate coding units (uci), prediction data constructed from prediction data of the first coding unit or units merged to form said intermediate coding unit, and
re-encoding the decoded video data in the second format (F2) by constructing the second coding structure (SC2i) based on the intermediate coding structure (SC1i).

13. Telecommunications device (2) comprising an interface (I1) for receiving a bitstream containing video data in a first format, characterized in that it comprises a transcoding module (4) according to claim 12.
